(19) United States
(12) Patent Application Publication
(10) Pub. No.: US 2021/0405367 A1
(43) Pub. Date: Dec. 30, 2021

(54) ELECTRONIC DEVICE

(71) Applicant: LG ELECTRONICS INC., Seoul (KR)

(72) Inventor: Sungchul SHIN, Seoul (KR)

(73) Assignee: LG ELECTRONICS INC., Seoul (KR)

(21) Appl. No.: 16/489,319

(22) PCT Filed: Jun. 13, 2019
(86) PCT No.: PCT/KR2019/007123

§ 371 Date: Aug. 27, 2019

(51) Int. Cl. G02B 27/01

(52) U.S. Cl. CPC G02B 27/0172; G02B 2027/0112

(57) ABSTRACT

The present invention relates to an electronic device. More particularly, the present invention relates to an electronic device used in virtual reality (VR), augmented reality (AR), mixed reality (MR), etc.

Disclosed is an electronic device including: a frame including at least one opening; a control unit mounted on the frame and generating an image; and a display unit fixed to the opening of the frame and emitting the image, in which the control unit includes a light source unit including a plurality of light emitting elements that emits a plurality of light sources having different wavelengths in the same direction as each other in order to provide the image, and a beam combining unit combining the plurality of light sources incident from the light source unit and emitting the combined light sources.

### TECHNICAL FIELD

The present invention relates to an electronic device. More particularly, the present invention relates to an electronic device used in virtual reality (VR), augmented reality (AR), mixed reality (MR), etc.

### BACKGROUND ART

Virtual reality (VR) refers to a specific environment or situation which is similar to reality created by artificial technology using a computer, etc., but is not reality or the technology itself.

Augmented reality (AR) refers to technology that combines a virtual object or information with a real environment to make it look like an object in an original environment.

Mixed reality (MR) or hybrid reality refers to technology that combines a virtual world and a real world to make a new environment or new information. In particular, an interaction between in objects which exist in reality and virtuality in real time is referred to as the mixed reality.

In this case, a created virtual environment or situation stimulates five senses of a user and makes spatial and temporal experiences similar to the reality, thereby making the user freely enter a boundary between the reality and imagination. Further, the user is capable of interacting with objects implemented in such an environment, such as giving an operation or a command by using a device which actually exists in addition to immersion in such an environment.

Recently, a research on a gear used in such a technical field has been actively conducted, and in particular, recently, a study on a glasses-type equipment that can be worn on a face of a user to view a real image and a virtual image together has been actively underway.

In order to create the virtual image which can be viewed by the user through the glass-type equipment, projection equipment is required and miniaturization of the projection equipment is required.

A generally used small project may have a structure illustrated in FIG. 1.

The small project used in the related art may include a plurality of light source elements 1a, 1b, and 1c having different wavelengths, a plurality of collimated lenses 2a, 2b, and 2c positioned in front of the plurality of light source elements, respectively and collecting light emitted from the plurality of light source elements, respectively in a predetermine direction, a combiner 3 combining light sources having different wavelengths into one optical axis, a fly eye lens or rod lens 4 making the light source emitted from the combiner be uniform, condensed lenses 5a and 5b condensing the light source and transferring the collected light source to a panel generating the image, and a display panel 6 receiving the light source from the condensed lens and generating the image.

Here, the plurality of light source elements 1a to 1c may be positioned so that the light source is emitted in direction crossing each other and the plurality of collimate lenses 2a to 2c may be positioned right in front of the plurality of light source elements, respectively and positioned in crossing directions.

Each of the collimated lenses 2a to 2c collect the light sources emitted from the light source elements in a predetermined direction and transfer the light sources to the combiner 3.

As illustrated, the combiner 3 is provided in an X shape and combines the light sources emitted through each of collimate lenses and transfers the light sources to the fly eye lens or the rod lens.

Thereafter, the condensed lenses 5a and 5b may condense the transferred light sources and the condensed light sources to the display panel and the display panel may generate and output the image to be viewed to the user.

Such a small project in the related art is positioned in directions in which the light sources having different light sources cross each other, and as a result, structural complexity of the combiner is increased and there is a limit in miniaturizing the project.

As a result, there is a limit in applying the small project in the related art to the glass-type device for viewing both the real image and the virtual image.

### DISCLOSURE

### Technical Problem

An embodiment of the present invention provides an electronic device used in virtual reality (VR), augmented reality (AR), mixed reality (MR), etc.

More specifically, an embodiment of the present invention provides an optimized glass-type electronic device which allows a light source unit to include a plurality of light emitting elements emitting a plurality of light sources having different wavelengths in the same direction to view both a real image and a virtual image while minimizing a size of a control unit that generates and outputs an image to be viewed to a user.

### Technical Solution

According to an example of the present invention, an electronic device include: a frame including at least one opening; a control unit mounted on the frame and generating an image; and a display unit fixed to the opening of the frame and emitting the image, in which the control unit includes a light source unit including a plurality of light emitting elements that emits a plurality of light sources having different wavelengths in the same direction as each other in order to provide the image, and a beam combining unit combining the plurality of light sources incident from the light source unit and emitting the combined light sources.

The control unit may further include a beam condensing unit receiving the combined light sources from the beam combining unit condensing and emitting the received light sources in a predetermined direction.

The beam condensing unit may include, an incident surface facing an emission surface of the beam combining unit, a first beam condensing lens having a first diameter and receiving the combined light sources from the beam combining unit and enlarging the received light sources, and a second beam condensing lens having a second diameter larger than the first diameter and condensing the combined light sources emitted from the first beam condensing lens from the first beam condensing lens and emitting the condensed light sources.

The control unit may further include a beam guide unit receiving the combined light sources from the beam condensing unit and transferring the received light sources to a display panel generating the image.

Here, the plurality of light emitting elements provided in the light source may be configured as one package.

Further, the beam combining unit may be positioned to face the light source unit and may include an incident surface on which the plurality of light sources is incident and an emission surface from which the combined light sources are emitted, the beam combining unit may elongate in a progress direction of the plurality of light sources, and a cross section of the incident surface of the beam combining unit may have any one shape of a square, a polygon, or a circle.

The beam combining unit may be formed as one rod lens with a medium, formed in a fiber bundle structure in which a plurality of rod lenses is formed as one bundle, or formed in a structure having a tunnel shape without the medium and having a mirror in a tunnel.

Here, a size of the incident surface may be different from the size of the emission surface and a size ratio forming each surface of the incident surface and the size ratio forming each surface of the emission surface are equal to each other.

As an example, in the light source unit, a plurality of light emitting elements generating light sources with different wavelengths may be configured as one package, the beam combining unit may be provided in the form of a fiber bundle in which a plurality of rod lenses is formed as one bundle, and incidence surfaces of the plurality of rod lenses are spaced apart from each other and adjacent to each other to face each of light emitting elements and emission surfaces of the plurality of rod lenses may be adjacent to each other to form one emission surface.

As another example, in the light source unit, a plurality of light emitting elements generating light sources with different wavelengths may be configured as one package, the beam combining unit may be provided as one rod lens, and the size of the incident surface of the beam combining unit provided as the one rod lens may be equal to or larger than the size of a maximum valid light source area which is an emission area of the plurality of light emitting elements.

Here, the plurality of light sources incident on the beam combining unit from the light source unit may diverge and converge at least one time in the beam combining unit.

As a result, a length of the beam combining unit may have a length in which the plurality of light sources converges at least two times and the plurality of light sources may converge on the emission surface of the beam combining unit.

Moreover, the length of the beam combining unit may be inversely proportional to valid divergence angles of the plurality of light sources and may be proportional to the size of the maximum valid light source area.

### Advantageous Effects

According to the present invention, an electronic device may provide an optimized glass-type electronic device which allows a light source unit to include a plurality of light emitting elements emitting a plurality of light sources having different wavelengths in the same direction to view both a real image and a virtual image while minimizing a size of a control unit that generates and outputs an image to be viewed to a user.

### DESCRIPTION OF DRAWINGS

FIG. 1 is a diagram for describing a problem of a small projected used in the related art.

FIG. 2 is a diagram for describing an electronic device according to an example of the present invention.

FIG. 3 is a diagram for describing an example of a control unit in FIG. 2.

FIGS. 4 to 6 are diagrams for describing various display schemes applicable to an optical display unit according to an example of the present invention.

FIG. 7 illustrates a basic structure of an image source panel in the control unit described in FIG. 3.

FIG. 8 is a diagram for describing various modification examples of a beam condensing unit, a beam guide unit, and a display panel applied to the image source panel illustrated in FIG. 7.

FIGS. 9 and 10 are diagrams for more specifically describing structures of a light source unit and a beam combining unit in the image source panel illustrated in FIG. 7.

FIG. 11 is a diagram for describing a modification example of the beam combining unit in the image source panel illustrated in FIG. 7.

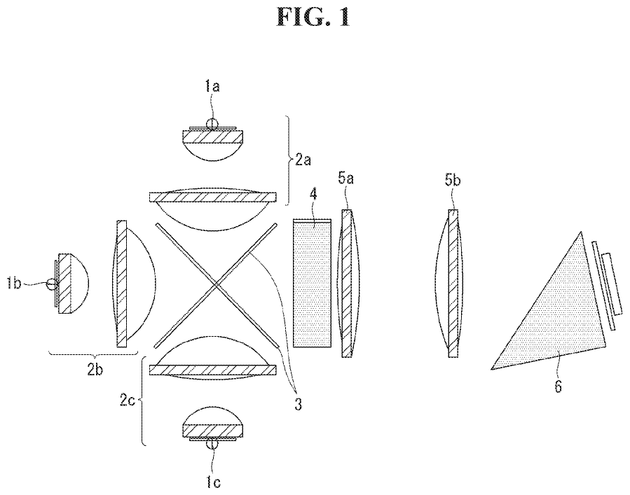

### MODE FOR INVENTION

Hereinafter, embodiments disclosed in this specification will be described in detail with reference to the accompanying drawings and the same or similar components are denoted by the same reference numerals regardless of a sign of the drawing, and duplicated description thereof will be omitted.

Further, in describing the embodiment disclosed in this specification, a detailed description of related known technologies will be omitted if it is determined that the detailed description makes the gist of the exemplary embodiment disclosed in this specification unclear.

Further, it is to be understood that the accompanying drawings are just used for easily understanding the exemplary embodiments disclosed in this specification and a technical spirit disclosed in this specification is not limited by the accompanying drawings and all changes, equivalents, or substitutes included in the spirit and the technical scope of the present invention are included.

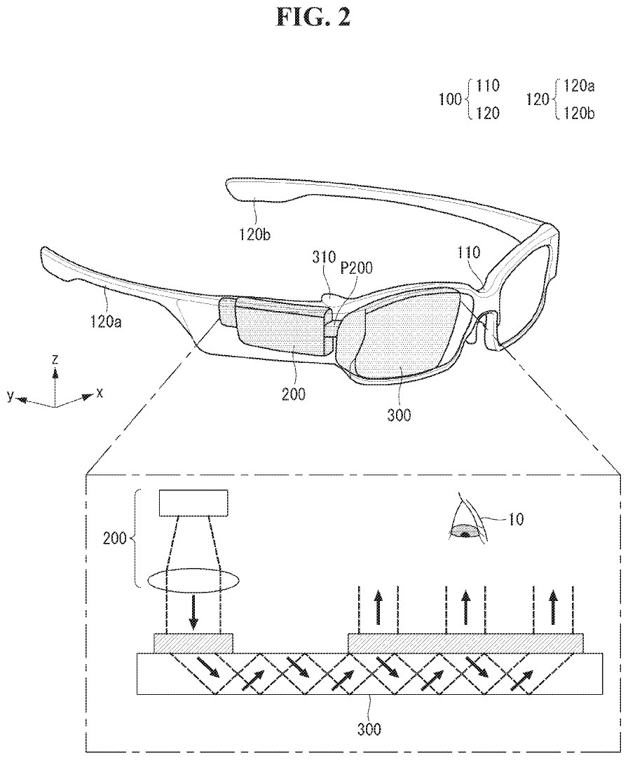

FIG. 2 is a diagram for describing an electronic device according to an example of the present invention.

As illustrated in FIG. 2, the electronic device according to an example of the present invention may include a frame 100, a control unit 200, and an optical display unit 300.

As illustrated in FIG. 2, the frame 100 may have a glass form worn on a face in a human body of a user 10, but the present invention is not limited thereto and the frame 100 may have a form such as goggles, etc., which are worn in close contact with the face of the user 10, etc.

Such a frame 100 may include a front frame 110 having at least one opening and first and second side frames 120 which extend in a first direction y intersecting the front frame 110 and are parallel to each other.

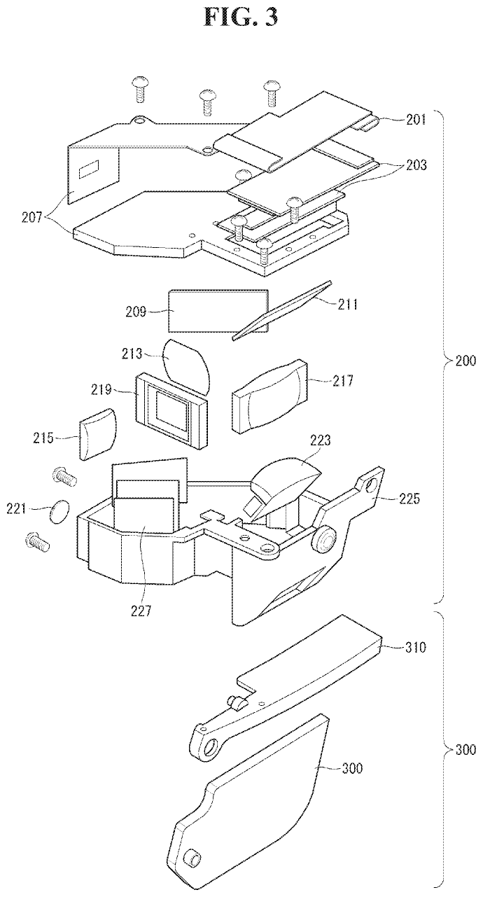

The control unit 200 may generate an image to be shown to the user 10 or a video in which the images are continued. Such a control unit 200 may include an image source generating the image and a plurality of lenses which diffuses and converges light generated from the image source. A detailed structure of the control unit 200 will be described in detail in FIG. 3 below.

Such a control unit 200 may be fixed to any one side frame 120 of the first and second side frames 120. As an example, the control unit 200 may be fixed to an inside or an outside of any one side frame 120 or embedded and integrally formed in any one side frame 120.

The optical display unit 300 may serve to show the image generated by the control unit 200 to the user 10 and may be made of a translucent glass material in order to allow the user 10 to see an external environment through an opening while showing the image to the user 10.

Such an optical display unit 300 may be inserted into or fixed to the opening included in the front frame 110 or positioned a rear surface (i.e., between the opening and the user 10) of the opening to be fixed to and provided in the front frame 110. In the present invention, as an example, a case where the optical display unit 300 is positioned on the rear surface of the opening and fixed to the front frame 110 is illustrated as an example.

As illustrated in FIG. 2, in such an electronic device, when image light for the image is incident on one side of the optical display unit 300 by the control unit 200, the image light is emitted to the other side through the optical display unit 300 to show the image generated by the control unit 200 to the user 10.

As a result, the user 10 may view the image generated by the control unit 200 simultaneously while viewing the external environment through the opening of the frame 100.

Since the control unit 200 generating the image is provided on any one side frame of the first and second side frames 120, such an electronic device may be relatively heavier than general glasses or goggles.

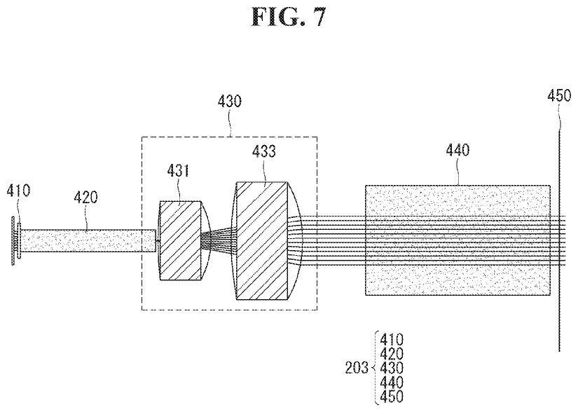

As a result, in order to cope with a difference of various head circumferences according to human body characteristics of the user 10, the electronic device according to an example of the present invention may have a structure in which at least one of a first length L1 of each of the first and second side frames or a first interval D1 between the first side frame 120 and the second side frame 120 is adjustable. As an example, the electronic device may have a structure in which at least one of the first length L1 or the first interval D1 may increase or decrease. A detailed description thereof will be described in FIG. 7 and subsequent figures after the control unit 200 and the optical display unit 300 are first described.

FIG. 3 is a diagram for describing an example of a control unit 200 in FIG. 2.

As illustrated in FIG. 3, as an example, the control unit 200 may include a first cover 207 and a second cover 225 that protect components inside the control unit 200 and form an outer shape of the control unit 200 and include a driving unit 201, an image source panel 203, a polarizing beam splitter filter (PBSF) 211, a mirror 209, a plurality of lenses 213, 215, 217, and 221, a fly eye lens (FEL) 219, a dichroic filter 227, and a freeform prism projection lens (FPL) 223 inside the first cover 207 and the second cover 225.

The first cover 207 and the second cover 225 may include a space in which the driving unit 201, the image source panel 203, the polarizing beam splitter filter (PB SF) 211, the mirror 209, the plurality of lenses 213, 215, 217, and 221, the fly eye lens (FEL) 219, and the freeform prism projection lens (FPL) 223 may be provided and package the driving unit 201, the image source panel 203, the polarizing beam splitter filter (PBSF) 211, the mirror 209, the plurality of lenses 213, 215, 217, and 221, the fly eye lens (FEL) 219, and the freeform prism projection lens (FPL) 223, which may be fixed to any one side frame 120a or 120b.

The driving unit 201 may supply a driving signal for controlling a video or image displayed on the image source panel 203 and interlock with a separate module driving chip provided inside the control unit 200 or outside the control unit 200. As an example, such a driving unit 201 may be provided in a form of a flexible printed circuits board (FPCB) and the FPCB may include a heatsink that discharges heat generated during driving to the outside.

The image source panel 203 may generate the image and emit light according to the driving signal provided by the driving unit 201. To this end, the image source panel 203 may be any one of a digital light processing (DLP), a digital mirror device (DMD), a liquid crystal on silicon (LCos), a micro crystal (LCD), or a micro Organic Light Emitting Diode (OLED).

The image source panel 203 may include a light source unit a light source and a display panel receiving the light source from the light source unit and generating the image in order to generate the image. A detailed structure of the image source panel 203 will be described below in FIG. 7 and subsequent figures.

The polarizing beam splitter filter (PBSF) 211 may separate the image light for the image generated by the image source panel 203 according to a rotational angle or block some image light or pass other some image light. Therefore, for example, when the image light emitted from the image source panel 203 includes a P wave as horizontal light and an S wave as vertical light, the polarizing beam splitter filter (PBSF) 211 may separate the P wave and the S wave into different paths or pass any one image light and block the other one image light. As an example, the polarizing beam splitter filter (PBSF) 211 may be provided as a cube type or a plate type.

The polarizing beam splitter filter (PBSF) 211 provided as the cube type may filter the image light formed by the P wave and the S wave and separate the filtered image light into different paths and the polarizing beam splitter filter (PB SF) 211 provided as the plate type may pass any one image light of the P wave and the S wave and block the other one image light.

The mirror 209 may reflect the image light polarized and separated by the polarizing beam splitter filter (PB SF) 211 and collect the reflected image light and make the collected image light be incident in the plurality of lenses 213, 215, 217, and 221.

The plurality of lenses 213, 215, 217, and 221 may include a convex lens and a concave lens and as an example, may include an I type lens and a C type lens. The plurality of lenses 213, 215, 217, and 221 repeatedly diffuses and converges the incident image light to enhance straightness of the image light.

The fly eye lens (FEL) 219 may receive the image light passing through the plurality of lenses 213, 215, 217, and 221 and emit the image light so that illuminance uniformity is more enhanced and extend an area where the image light having uniform illuminance.

The dichroic filter 227 may include a plurality of film layers or lens layers and the dichroic filter 227 may transmit light of a specific wavelength band of the image light incident from the fly eye lens 219, reflect light of the remaining specific wavelength band to correct a color sense of the image light. The image light that transmits the dichroic filter 227 may be emitted to the optical display unit 300 through the freeform projection prism projection lens 223.

The optical display unit 300 may receive the image light emitted from the control unit 200 and emit the image incident in a direction in which an eye of the user 10 is positioned so that the user 10 views the incident image light with an eye thereof.

The optical display unit 300 may be fixed to the front frame 110 through a separate fixation member or fixed into the opening provided in the front frame 110.

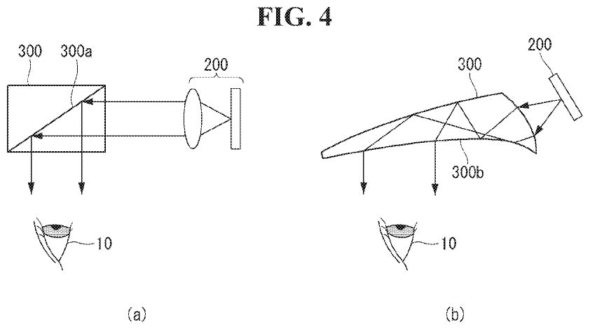

Hereinafter, in FIGS. 4 to 6, various forms of the optical display unit 300 and various schemes in which the incident image light is emitted will be described.

FIGS. 4 to 6 are diagrams for describing various display schemes applicable to an optical display unit 300 according to an example of the present invention.

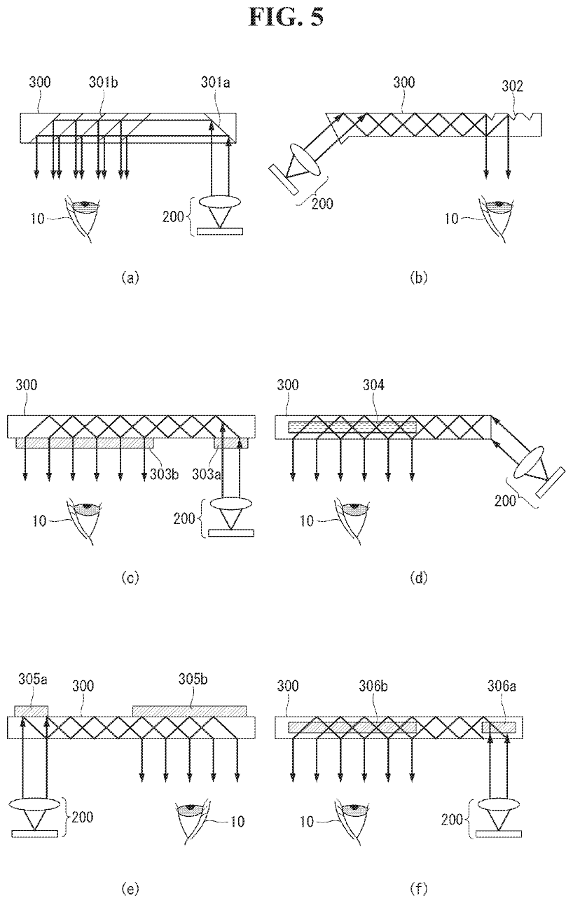

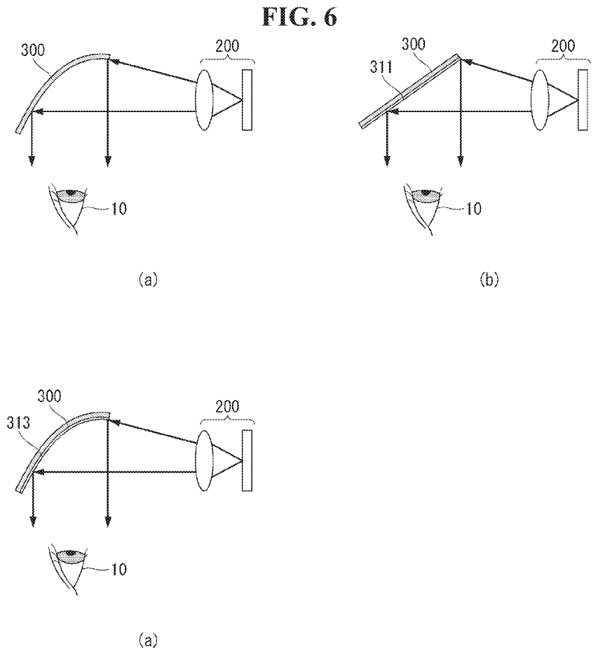

More specifically, FIG. 4 is a diagram for describing an example of a prism type optical element applicable to an optical display unit 300 according to an example of the present invention, FIG. 5 is a diagram for describing an example of a waveguide type optical element applicable to an optical display unit 300 according to an example of the present invention, and FIG. 6 is a diagram for describing an example of a surface reflection type optical element applicable to an optical display unit 300 according to an example of the present invention.

The optical display unit 300 according to an example of the present invention may be translucent so as for the user 10 to visually recognize the external environment and recognize the image generated by the control unit 200 and as an example, may be formed as an optical element including a material such as the glasses.

As the optical element applicable to the optical display unit 300 according to an example of the present invention, the optical elements illustrated in FIGS. 4 to 6 may be used and besides, optical elements of various schemes including a retina scanning scheme, etc., may be used.

As illustrated in FIG. 4, the prism type optical element may be used in the optical display unit 300 according to an example of the present invention.

As an example, as illustrated in FIG. 4(a), as the prism type optical element, a flat type glass optical element may be used in which a surface on which the image light is incident and a surface from which the image light is emitted are flat or as illustrated in FIG. 4(b), a freeform glass optical element may be used in which a surface 300b from which the image light is emitted is formed by a curved surface.

The flat type glass optical element may receive the image light generated by the control unit 200 on a flat side surface and reflect the incident image light through a total reflection mirror 300a provided therein, and emit the reflected image light toward the user 10. Here, the total reflection mirror 300a provided in the flat type glass optical element may be formed in the flat type glass optical element by a laser.

The freeform glass optical element is configured in such a manner that a thickness decreases as a distance from the incident surface increases to receive the image light generated by the control unit 200 through a side surface having the curved surface and totally reflect the received image light therein, and emit the totally reflected image light toward the user 10.

As illustrated in FIG. 5, a waveguide type optical element or a light guide optical element (LOE) may be used in the optical display unit 300 according to an example of the present invention.

As an example, the waveguide or light guide type optical element may include a segmented beam splitter type glass optical element illustrated in FIG. 5(a), a sawtooth prism type glass optical element illustrated in FIG. 5(b), a glass optical element having a diffractive optical element (DOE) illustrated in FIG. 5(c), a glass optical element having a hologram optical element (HOE) illustrated in FIG. 5(d), a glass optical element having a passive grating illustrated in FIG. 5(e), and a glass optical element having an active grating illustrated in FIG. 5(f).

The segmented beam splitter type glass optical element illustrated in FIG. 5(a) may include a total reflection mirror 301a at a side on which an optical image is incident and a segmented beam splitter 301b at a side from which the optical image is emitted, in the glass optical element as illustrated in FIG. 4(a).

As a result, the optical image generated by the control unit 200 is totally reflected by the total reflection mirror 301a in the glass optical element, the totally reflected optical image is guided in a longitudinal direction of the glass and partially separated and emitted by the segmented reflection mirror 301b to be recognized by a vision of the user 10.

In the sawtooth prism type glass optical element illustrated in FIG. 5(b), the image light of the control unit 200 is incident on a side surface of the glass in a diagonal direction and totally reflected in the glass and emitted to the outside of the glass by a sawtooth shaped concavity and convexity 302 provided at a side to which the optical image is emitted to be recognized by the vision of the user 10.

In the glass optical element having the diffractive optical element (DOE) illustrated in FIG. 5(c), a first diffractive unit 303a may be provided on a surface on which the optical image is incident and a second diffractive unit 303b may be provided on a surface from which the optical image is emitted. The first and second diffractive units 303a and 303b may be provided in a form in which a specific pattern is patterned or a separate diffractive film is attached onto the surface of the glass.

As a result, the optical image generated by the control unit 200 is diffracted while being incident, totally reflected, and guided in the longitudinal direction of the glass through the first diffractive unit 303a and emitted through the second diffractive unit 303b to be recognized by the vision of the user 10.

In the glass optical element having the hologram optical element (HOE) illustrated in FIG. 5(d), an out-coupler 304 may be provided in a glass at the side from which the optical image is emitted. As a result, the optical image is incident from the control unit 200 in the diagonal direction through the side surface of the glass, totally reflected and guided in the longitudinal direction of the glass, and emitted by the out-coupler 304 to be recognized by the vision of the user 10. A structure of the hologram optical element may be changed little by little and subdivided into a structure having the passive grating and a structure having the active grating.

The glass optical element having the passive grating illustrated in FIG. 5(e) may include an in-coupler 305a provided on a surface opposite to the side on which the optical image is incident and an out-coupler 305b provided on a surface opposite to the glass surface from which the optical image is emitted. Here, the in-coupler 305a and the out-coupler 305b may be provided in a film form having the passive grating

As a result, the optical image incident on the glass surface at the side of the glass on which the optical image is incident is totally reflected and guided in the longitudinal direction of the glass by the in-coupler 305a provided on the opposite surface and emitted through the opposite surface of the glass by the out-coupler 305b to be recognized by the vision of the user 10.

The glass optical element having the active grating illustrated in FIG. 5(f) may include an in-coupler 306a formed as the active grating in the glass at the side on which the optical image is incident and an out-coupler 306b formed as the active grating in the glass at the side from which the optical image is emitted.

As a result, the optical image incident on the glass is totally reflected and guided in the longitudinal direction of the glass by the in-coupler 306a and emitted to the outside of the glass by the out-coupler 306b to be recognized by the vision of the user 10.

As the surface reflection type optical element applicable to the optical display unit 300 according to an example of the present invention, a freeform combiner type illustrated in FIG. 6(a), a flat HOE type illustrated in FIG. 6(b), and a freeform HOE type illustrated in FIG. 6(c) may be used.

As the freeform combiner type surface reflection type optical element illustrated in FIG. 6(a), in order to serve as a combiner, a freeform combiner glass 300 may be used in which a plurality of flat surfaces having different incident angles of the optical image is formed as one glass 300 and formed to have the curved surface as a whole. In the freeform combiner glass 300, the incident angle of the optical image may be incident differently for each area and emitted to the user 10.

In the flat HOE type surface reflection type optical element illustrated in FIG. 6(b), a hologram optical element (HOE) 311 may be provided to coated or patterned on the surface of the flat glass and the optical image incident by the control unit 200 is reflected on the surface of the glass through the hologram optical element 311 and emitted toward the user 10 through the hologram optical element 311 again.

In the freeform HOE type surface reflection type optical element illustrated in FIG. 6(c), a hologram optical element (HOE) 313 may be provided to be coated or patterned on the surface of a freeform-shaped glass and an operation principle may be the same as that described in FIG. 6(b).

As described above, in the optical display unit 300 according to an example of the present invention, one of the prism type optical element, the waveguide type optical element, the optical guide optical element (LOE), or the surface reflection type optical element may be selected and used.

In the electronic device according to an example of the present invention, which includes the control unit 200 and the optical display unit 300, in order to further enhance the wearing sense of the user 10, at least one of a first length L1 of each of the first and second side frames 120 and a first interval D1 between the first side frame 120 and the second side frame 120 may be adjustable. This will be described in more detail.

FIG. 7 is a diagram for specifically describing a structure of an image source panel 203 in the control unit described in FIG. 3.

As illustrated in FIG. 7, the image source panel 203 included in the control unit 200 of the present invention may include a light source unit 410, a beam combining unit 420, a beam condensing unit 430, a beam guide unit 440, and a display panel 450.

The light source unit 410 may include a plurality of light emitting elements that emits a plurality of light sources having different wavelengths in the same direction as each other in order to provide the image. The plurality of light emitting elements provided in the light source unit 410 may be configured as one package.

As a result, the light source unit 410 including the plurality of light emitting elements may emit the plurality of light sources having different wavelengths in the same direction as each other.

The beam combining unit 420 may uniformly combine the plurality of light sources incident from the light source unit 410 and emit the combined light sources. The beam combining unit 420 may be positioned to face the light source unit 410. The beam combining unit 420 may be extended in a direction that the plurality of light sources incident from the light source unit 410 progress. The beam combining unit 420 may include an incident surface on which the plurality of light sources from the light source unit 410 provided and an emission surface from which the combined light sources are emitted.

The beam combining unit 420 may be formed as one rod lens with a medium (1), formed in a fiber bundle structure in which a plurality of rod lenses is formed as one bundle (2), or formed in a structure having a tunnel shape without the medium and having a mirror in the tunnel (3).

In FIG. 7, a case where the beam combining unit 420 is configured by one rod lens with the medium is illustrated as an example, but the present disclosure is not particularly limited thereto.

The beam condensing unit 430 receives the combined light sources from the beam combining unit 420 and condenses the received light sources in a predetermined direction to emit the light sources to the beam guide unit 440.

The beam condensing unit 430 includes the incident surface facing the emission surface of the beam combining unit 420. The beam condensing unit 430 may include a plurality of beam condensing lenses. As an example, as illustrated in FIG. 7, the beam condensing unit 430 may include a first beam condensing lens 431 and a second beam condensing lens 432. Here, as an example, the first and second beam condensing lenses 431 and 432 may adopt collimated condensed lenses.

The first beam condensing lens 431 may have a first diameter and receive the light sources combined by the beam combining unit 420 and enlarge the received light sources. The second beam condensing lens 432 may have a second diameter larger than the first diameter, and condense the combined light sources emitted from the first beam condensing lens 431 and emit the condensed light sources.

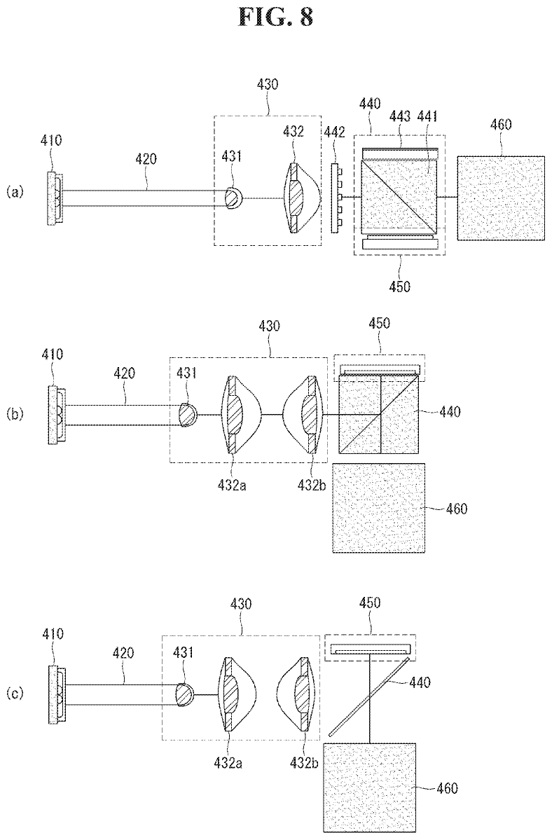

However, the structure of the beam condensing unit 430 is not limited only to FIG. 7, but may be modified to various shapes, which will be described with reference to FIG. 8.

The beam guide unit 440 may receive the combined light sources from the beam condensing unit 430 and transfer the received light sources to the display panel 450.

The display panel 450 may receive the combined light sources from a beam guide and generate the image to be viewed to the user.

The display panel 450 may adopt any one of digital light processing (DLP), a digital mirror device (DMD), a liquid crystal on silicon (LCoS), a micro LCD, or a micro OLED and besides, any other display panel 450 capable of generating the image may be used.

In the image source panel according to the present invention, the beam condensing unit 430, the beam guide unit 440, and the display panel 450 may be variously modified. This will be described below.

FIG. 8 is a diagram for describing various modification examples of a beam condensing unit 430, a beam guide unit 440, and a display panel 450 applied to the image source panel illustrated in FIG. 7.

The beam condensing unit 430, the beam guide unit 440, and the display panel 450 applied to the image source panel of the present invention may be provided in various shapes as illustrated in FIG. 8.

As an example, the beam guide unit 440 may be modified in the image source panel of the present invention. As an example, as illustrated in FIG. 8(a), the beam guide unit 440 may be configured to include a polarizing beam splitter cube (PBS-cube) 441, a PBS-HWP 442, and a quarter wave plate (QWP) 443 which are polarizers for polarizing the light source as an example.

Thereafter, the image generated by the LCoS which is the display panel 450 may be incident on a projection lens. Here, the projection lens may include a Polarization Beam Splitter Filter (PBSF) 211, a mirror 209, a plurality of lenses 213, 215, 217, and 221, a Fly Eye Lens (FEL) 219, a Dichroic filter 227. and a Freeform prism Projection Lens (FPL) 223.

Alternatively, in the image source panel, the beam condensing unit 430 may be partially modified. As an example, in FIG. 8(a), a case where the beam condensing unit 430 includes first and second beam condensing lenses 431 and 432 is illustrated as an example, but as illustrated in FIG. 8(b), in the beam condensing unit 430, a plurality of second beam condensing lenses 432a and 432b having a relatively large diameter may be provided and the plurality of second beam condensing lenses 432a and 432b may be provided to face each other.

Further, FIGS. 8(a) and 8(b) are mixed to be provided as illustrated in FIG.

Hereinafter, the structures of the light source unit 410 and the beam combining unit 420 will be described in more detail.

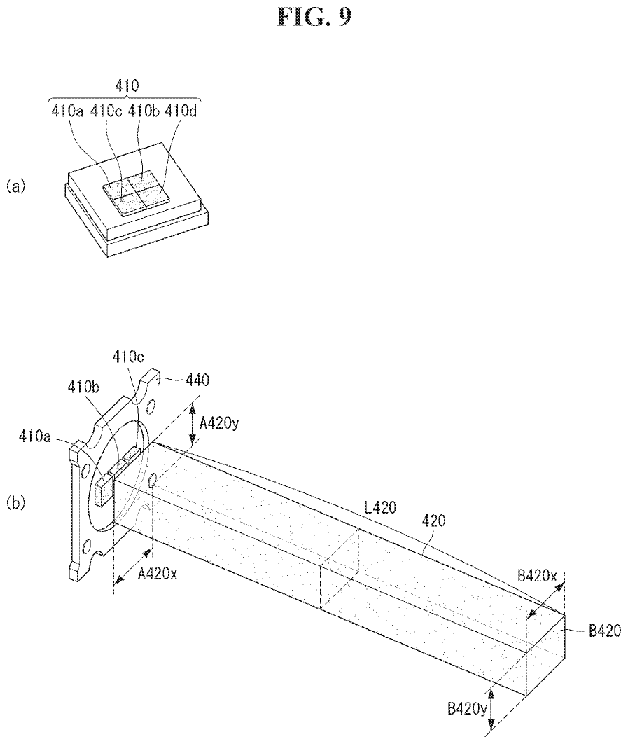

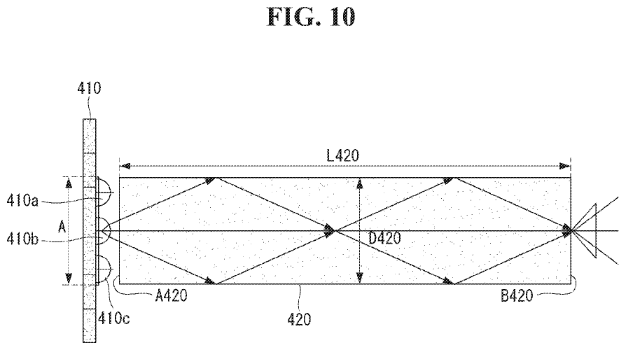

FIGS. 9 and 10 are diagrams for more specifically describing structures of a light source unit 410 and a beam combining unit 420 in the image source panel illustrated in FIG. 7.

In the image source panel according to the present invention, the light source unit 410 may include a plurality of light emitting elements 410a, 410b, and 410c that emits a plurality of light sources having different wavelengths in the same direction as each other as illustrated in FIG. 9(a).

Here, the plurality of light emitting elements 410a, 420b, and 410c may emit red R, green, G, and blue B which are light sources having different wavelengths and emission directions may be the same as each other. Here, the plurality of light emitting elements 410a, 420b, and 410c generating different light sources may be configured as one package.

The beam combining unit 420 may elongate in directions in which the plurality of light sources emitted from each of the plurality of light emitting elements 410a, 410b, and 410c progresses as illustrated in FIG. 9(b). The beam combining unit 420 may be positioned to face the light source unit 410 and may include an incident surface A420 on which the plurality of light sources is incident and an emission surface B420 from which the combined light sources are emitted.

Here, in the beam combining unit 420, a cross section of the incident surface A420 that receives the plurality of light sources from the beam combining unit 420 may have any one shape of a square, a polygon, or a circle. As an example, in FIG. 9(b), it is illustrated that the cross section of the incident surface A420 of the beam combining unit 420 has the square, but may have various shapes as described above.

Further, when the beam combining unit 420 is provided as one rod lens, a size of the incident surface A420 of the beam combining unit 420 provided as one rod lens may be equal to or larger than the size of maximum valid light source area which is emission areas of the plurality of light emitting elements 410a, 410b and 410c.

Here, the size of the incident surface A420 and the size of the emission surface B420 may be different from each other and a size ratio forming each surface of the incident surface A420 may be equal to the size ratio forming each surface of the emission surface B420.

As an example, in FIG. 9(b), when the incident surface A420 of the beam combining unit 420 is formed in a quadrangle, a ratio of a vertical length A420 y to a horizontal length A420x of the incident surface A420 formed in the quadrangle may be equal to a ratio of a vertical length B420y to a horizontal length B420x of the emission surface B420.

As illustrated in FIG. 10, the beam combining unit 420 may have a length in which the plurality of light sources on the beam combining unit 420 from the light source unit 410 diverges and converges at least one or more times.

More specifically, as illustrated in FIG. 10, a length L420 of the beam combining unit 420 has a length at which the plurality of light sources converge at least two times and the plurality of light sources may converge on the emission surface B420 of the beam combining unit 420.

As such, the beam combining unit 420 according to the present invention has a length L420 in which the plurality of light sources emitted from the plurality of light emitting elements 410a, 410b, and 410c provided in the light source unit 410, respectively may be uniformly combined in the bema combining unit 420 to uniformly form the light source on the emission surface B420 of the beam combining unit 420 and the size ratios of the light sources on the emission surface A420 and the emission surface B420 of the beam combining unit 420 may be equal to each other.

Here, the length L420 of the beam combining unit 420 may be inversely proportional to valid divergence angles a of the plurality of light sources and may be proportional to the size of the maximum valid light source area.

So far, a case where in the beam combining unit 420, one rod lens incident surface A420 is in contact with the plurality of light emitting elements 410a, 410b, and 410c, but the present invention is not particularly limited thereto and the beam combining unit 420 may be formed by a fiber bundle in which a plurality of rod lenses is formed as one bundle.

Hereinafter, a case where the beam combining unit 420 is formed by the fiber bundle as described above will be described.

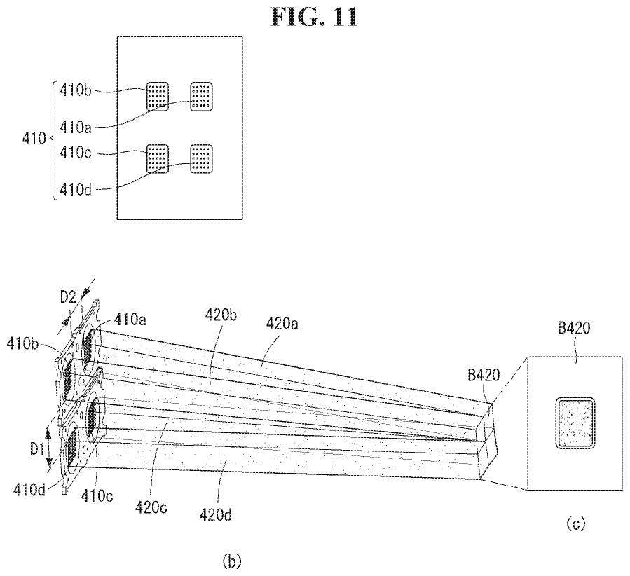

FIG. 11 is a diagram for describing a modification example of the beam combining unit 420 in the image source panel illustrated in FIG. 7.

As illustrated in FIG. 11(a), in the light source unit 410, a plurality of light emitting elements 410a, 410b, 410c, and 410d generating light sources having different wavelengths may be configured as one package.

Moreover, as illustrated in FIG. 11(b), the beam combining unit 420 may be provided as a fiber bundle form in which a plurality of rod lenses 420a, 420b, 420c, and 420d is formed as one bundle.

Here, the plurality of rod lenses 420a, 420b, 420c, and 420d may be spaced apart from each other and may be positioned adjacent to each other to face the plurality of light emitting elements 410a, 410b, and 410c, respectively.

As an example, the incident surface A420 of each of the plurality of rod lenses may be positioned to face each of the plurality of light emitting elements 410a, 410b, and 410 and the plurality of rod lenses 410a, 410b, and 410c may be positioned spaced apart from each other by predetermined intervals such as D1 and D2 in a vertical or horizontal direction.

Moreover, the emission surfaces B420 of the plurality of respective rod lenses are adjacent to each other to form one emission surface B420.

To this end, lengths of the plurality of respective rod lenses 420a, 420b, 420c, and 420d may have lengths in which light sources having different wavelengths emitted from the plurality of light emitting elements 410a, 410b, and 410c, respectively converge and in the case of the emission surface B420 of each of the plurality of rod lenses 420a, 420b, 420c, and 420d, the emission surface B420 may be provided in lengths in which light sources having different wavelengths converge and respective emission surfaces B420 are not spaced apart from each other and side surfaces are in contact with each other to be views as if one combined light source is emitted to the emission surface B420 of each of the plurality of rod lenses as illustrated in FIG. 11(c).

As described above, according to the present invention, an electronic device may provide an optimized glass-type electronic device which allows a light source unit to include a plurality of light emitting elements emitting a plurality of light sources having different wavelengths in the same direction to view both a real image and a virtual image while minimizing a size of a control unit that generates and outputs an image to be viewed to a user.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. An electronic device comprising:
a frame including at least one opening;
a control unit mounted on the frame and generating an image; and
a display unit fixed to the opening of the frame and emitting the image,
wherein the control unit includes:
a light source unit including a plurality of light emitting elements that emits a plurality of light sources having different wavelengths in the same direction in order to provide the image, and
a beam combining unit combining the plurality of light sources incident from the light source unit and emitting the combined light sources.

2. The electronic device of claim 1, wherein the control unit further includes a beam condensing unit receiving the combined light sources from the beam combining unit, condensing and emitting the received light sources in a predetermined direction.

3. The electronic device of claim 2, wherein the beam condensing unit includes:
an incident surface facing an emission surface of the beam combining unit,
a first beam condensing lens having a first diameter and receiving the combined light sources from the beam combining unit and enlarging the received light sources, and
a second beam condensing lens having a second diameter larger than the first diameter and condensing the combined light sources emitted from the first beam condensing lens from the first beam condensing lens and emitting the condensed light sources.

4. The electronic device of claim 2, wherein the control unit further includes a beam guide unit receiving the combined light sources from the beam condensing unit and transferring the received light sources to a display panel generating the image.

5. The electronic device of claim 1, wherein the plurality of light emitting elements provided in the light source is configured as one package.

6. The electronic device of claim 1, wherein the beam combining unit is positioned to face the light source unit and includes an incident surface on which the plurality of light sources is incident and an emission surface from which the combined light sources are emitted,
wherein the beam combining unit elongates in a progress direction of the plurality of light sources, and
wherein a cross section of the incident surface of the beam combining unit has any one shape of a square, a polygon, or a circle.

7. The electronic device of claim 6, wherein the beam combining unit is formed as one rod lens with a medium, formed in a fiber bundle structure in which a plurality of rod lenses is formed as one bundle, or formed in a structure having a tunnel shape without the medium and having a mirror in a tunnel.

8. The electronic device of claim 6, wherein a size of the incident surface is different from the size of the emission surface and a size ratio forming each surface of the incident surface and the size ratio forming each surface of the emission surface are equal to each other.

9. The electronic device of claim 6, wherein in the light source unit, a plurality of light emitting elements generating light sources with different wavelengths is configured as one package,
wherein the beam combining unit is provided in the form of a fiber bundle in which a plurality of rod lenses is formed as one bundle,
wherein incidence surfaces of the plurality of rod lenses are spaced apart from each other and adjacent to each other to face each of light emitting elements, and
wherein emission surfaces of the plurality of rod lenses are adjacent to each other to form one emission surface.

10. The electronic device of claim 6, wherein in the light source unit, a plurality of light emitting elements generating light sources with different wavelengths is configured as one package,
wherein the beam combining unit is provided as one rod lens, and
wherein the size of the incident surface of the beam combining unit provided as the one rod lens is equal to or larger than the size of a maximum valid light source area which is an emission area of the plurality of light emitting elements.

11. The electronic device of claim 1, wherein the plurality of light sources incident on the beam combining unit from the light source unit diverges and converges at least one time in the beam combining unit.

12. The electronic device of claim 11, wherein a length of the beam combining unit has a length in which the plurality of light sources converges at least two times and the plurality of light sources converges on the emission surface of the beam combining unit.

13. The electronic device of claim 11, wherein the length of the beam combining unit is inversely proportional to valid divergence angles of the plurality of light sources and is proportional to the size of the maximum valid light source area.
